(19) United States
(12) Patent Application Publication
(10) Pub. No.: US 2024/0330301 A1
(43) Pub. Date: Oct. 3, 2024

(54) Identification of Actions in Artificial Intelligence Planning

(71) Applicant: International Business Machines Corporation, Armonk, NY (US)

(72) Inventors: Harsha Kokel, Milpitas, CA (US); Junkyu Lee, San Diego, CA (US); Michael Katz, Goldens Bridge, NY (US); Shirin Sohrabi Araghi, Briarcliff Manor, NY (US); Kavitha Srinivas, Port Chester, NY (US)

(21) Appl. No.: 18/127,357

(22) Filed: Mar. 28, 2023

(51) Int. Cl. G06F 16/2455; G06F 16/22

(52) U.S. Cl. CPC G06F 16/2456; G06F 16/2282

(57) ABSTRACT

Automated improved computer mechanisms are provided for improving the way in which a lifted successor generation (LSG) solution to an artificial intelligence (AI) planning problem is processed. An artificial intelligence (AI) planning problem is received that includes definitions for a plurality of operators. An initial label set, which defines an initial version of an action space, is created, with each label corresponding to an operator. A label reduction is performed on the label set to obtain a reduced label set (seed set) that defines a reduced action space. The AI planning problem is represented as a LSG problem comprising a set of tables and a join query. A LSG module is executed on the LSG problem using the seed set to process the join query and generate applicable action(s) as a solution to the AI planning problem which are then output for further AI operations.

### BACKGROUND

The present application relates generally to an improved data processing apparatus and method and more specifically to an improved computing tool and improved computing tool operations/functionality for automatically identifying actions in an artificial intelligence planning operation.

Two main subfields of artificial intelligence (AI) that deal with sequential decision making are Reinforcement Learning (RL) and AI Planning. Each of these approaches has their strong sides and their weaknesses. AI Planning is a model-based approach, relying on a symbolic model to guide the search for a solution. It does not require additional data beyond the symbolic model, is agnostic to the problem behind the model, and is able to scale to rather large instances. A pure RL system, on the other hand, does not require a symbolic model, but lacks the advantages of AI Planning, being extremely data hungry, domain specific, requiring adaptation and often retraining from scratch when moving to a sufficiently different task. There have been some efforts to combine AI Planning and RL techniques.

Planning domains, written in the Planning Domain Definition Language (PDDL), are fundamentally relational. In AI planning formulated as a PDDL task, the task is defined with language, actions, initial state, and a goal state. Actions are defined by an action name, preconditions, and effects. The task is to find a sequence of actions which, when executed from the initial state, reaches the goal state. The search starts with the initial state and explores all applicable actions. Applicable actions are the set of actions whose preconditions are satisfied in the current state. A list of grounded actions is maintained, i.e., specific instantiations of actions that are determined to be applicable actions. The solution to this PDDL task is impractical with large domains, as it requires maintaining large lists of grounded actions, which is often referred to as “hard-to-ground”.

To avoid grounding and maintaining a large list of grounded actions, a lifted successor generator has been proposed that can identify the list of applicable actions from a given state and lifted action models. Lifted successor generator converts the current state to a database and the preconditions of the lifted action model to a join query. The result of the join query provides a list of applicable actions in that state.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a computer implemented method is provided that comprises receiving an artificial intelligence (AI) planning problem including definitions for a plurality of operators and creating an initial version of a label set, which defines an initial version of an action space, with the label set including a plurality of labels, and with each label of the plurality of labels respectively corresponding to the operators of the plurality of operators. The computer implemented method further comprises performing, automatically and by machine logic, a label reduction on the initial version of the label set to obtain a reduced version of the label set that defines a reduced action space, wherein the reduced version of the label set is a seed set. The computer implemented method further comprises representing the AI planning problem as a lifted successor generation problem comprising a set of tables and at least one join query on the set of tables. In addition, the computer implemented method comprises executing a lifted successor generation module on the lifted successor generation problem using the seed set to process the at least one join query and generate one or more applicable actions as a solution to the AI planning problem. Moreover, the computer implemented method comprises outputting the one or more applicable actions for the AI planning problem for further AI operations.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example illustrative embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIGS. 1A and 1B depict the PDDL task example of a gripper for purposes of demonstrating the improvements of the illustrative embodiments;

FIG. 2 is a block diagram of a first embodiment of a system according to the present invention;

FIG. 3 is a flowchart outlining an example operation for resolving an AI planning problem with a reduced label set in accordance with one illustrative embodiment;

FIG. 4 is a block diagram illustrating an example of machine logic for performing an AI Planning task using a reduced label set in accordance with one illustrative embodiment;

FIG. 5 is a flowchart outlining an operation for generating a parameter seed set in accordance with one illustrative embodiment;

FIG. 6 is an example diagram illustrating an example of a set of initial states and their corresponding database or tables for performing a lifted successor generation solution to an AI Planning task in accordance with one illustrative embodiment;

FIG. 7 is an example diagram depicting an example of a first methodology for reducing the size of the database tables used to perform join operations for a lifted successor generation solution in accordance with one illustrative embodiment;

FIG. 8 is an example diagram depicting an example of a second methodology for reducing the size of the database tables used to perform join operations for a lifted successor generation solution in accordance with one illustrative embodiment; and

FIG. 9 is a flowchart outlining an example operation for improving a lifted successor generation solution to an AI Planning task based on a parameter seed set and preprocessing of database tables for a database join operation in accordance with one illustrative embodiment.

### DETAILED DESCRIPTION

The illustrative embodiments provide an improved computing tool and an improved computing tool functionality/operations that are specifically directed to the AI Planning operations. AI Planning is a process directed to realizing action sequences for execution by intelligent agents, e.g., autonomous robots, unmanned vehicles, or other AI computer model applications. From a state diagram point of view, AI Planning identifies the sequence of actions that are applicable for transitioning from an initial or current state to a goal state for the corresponding AI system. The illustrative embodiments improve the process by which AI Planning is performed by first reducing the action space of lifted actions to seed actions. In some illustrative embodiments, using a lifted successor generation approach which treats the various states as a database and in which database queries are formed based on lifted action preconditions, the seed actions are used to reduce the size of the data structures used to perform database join operations for processing such database queries and identifying available actions, e.g., removing rows from the database tables. In some illustrative embodiments, the seed actions may be used to reduce the number of data structures used to perform such database join operations, e.g., removing tables from the processing of the database join operation.

As such, the following description will first be directed to identifying seed actions, which serve as a basis for the other operations of the illustrative embodiments to reduce data structures used to perform database join operations. Thereafter, the improved computer functionality and improved computing tools for improving such database join operations based on such seed action identification will be described. It should be appreciated that the illustrative embodiments provide an automated way of reducing action label sets by casting the operator parameter reduction as a classical planning problem and identifying seed action labels which results in improved sample efficiency while learning RL policies, i.e., sequences of actions that will transition from an initial state to a target state. It should also be appreciated that the illustrative embodiments provide an automated way of reducing the database content for representing states when performing a lifted successor generation operation by specifically filtering the database content based on the identified reduce action label set, also referred to herein as the seed actions.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing illustrative embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more illustrative embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) illustrative embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate illustrative embodiments, may also be provided in combination in a single embodiment. Conversely, various features of the invention, which are, for brevity, described in the context of a single embodiment, may also be provided separately or in any suitable sub-combination.

It is also beneficial, before continuing the discussion of the illustrative embodiments, to have an understanding of some of additional terms used herein. The following is a listing of terms and their corresponding understanding, as they may be used throughout this description.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment or illustrative embodiment: see definition of “present invention” above—similar cautions apply to the term “embodiment” or “illustrative embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Set of thing(s): does not include the null set; “set of thing(s)” means that there exist at least one of the thing, and possibly more; for example, a set of computer(s) means at least one computer and possibly more.

Virtualized computing environments (VCEs): VCEs can be stored as “images.” A new active instance of the VCE can be instantiated from the image. Two types of VCEs are virtual machines and containers. A container is a VCE that uses operating-system-level virtualization. This refers to an operating system feature in which the kernel allows the existence of multiple isolated user-space instances, called containers. This isolated user-space instances may look like real computers from the point of view of programs running in them. A computer program running on an ordinary operating system can see all resources (connected devices, files and folders, network shares, CPU power, quantifiable hardware capabilities) of that computer. However, programs running inside a container can only see the container's contents and devices assigned to the container.

Cloud computing system: a computer system that is distributed over the geographical range of a communication network(s), where the computing work and/or computing resources on the server side are primarily (or entirely) implemented by VCEs (see definition of VCEs in previous paragraph). Cloud computing systems typically include a cloud orchestration module, layer and/or program that manages and controls the VCEs on the server side with respect to instantiations, configurations, movements between physical host devices, terminations of previously active VCEs and the like.

Atom: For first-order predicate logic, an atom is a predicate symbol together with its arguments, each argument being either an object or variable. Any fact of the domain or an element from a database can be represented as an atom.

Lifted: In the context of first-order logic, lifted refers to a formula or an operation where execution does not require the materialization of all the objects in the domain. For example, a lifted atom is an atom with a variable, and lifted inference is an inference operation where all objects are not materialized.

Free variable: A variable that is not yet materialized to an object.

Lifted action model/Schematic operator: This is a description of the action in the PDDL. It contains preconditions and effects. Preconditions are a set of conditions that must be satisfied for action to be applied. Effects indicate conditions that change in the state as a result of performing that action. It can be one of add or delete effects. Add effects specifies the atoms added to the next state and delete effects specifies the atoms that are deleted.

Grounded: In the context of first-order logic, grounded or grounding refers to a formula or operation where all the variables are materialized to some object. For example, a grounded atom is an atom with zero free variables, grounded operator is an operator with zero free variables.

Delete free planning: Is a planning task where the operators do not have delete effects.

It should be appreciated that the terms seed parameters, seed sets, seeds, and seed actions are used interchangeably herein. The same is true of the terms lifted action model and schematic operators, which are used interchangeably herein.

Having set forth some definitions of terms, it should further be appreciated that the present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the internet using an Internet Service Provider). In some illustrative embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to illustrative embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various illustrative embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the illustrative embodiments are directed to improving AI Planning tasks by specifically providing an improved computing tool and improved computing tool functionality for reducing the action space that needs to be considered by identifying seed actions, and then using those seed actions to reduce the size and number of database data structures processed by database joins to perform lifted successor generation for identifying applicable ground actions given a state of the particular system, e.g., autonomous robot, unmanned vehicle, or other state of another AI model based system. The AI Planning tasks may be described in a planning domain description language (PDDL). AI Planning tasks described in a PDDL induce transition graphs with states as nodes and transitions between states a labeled edges. The labeled transition systems (LTS) feature a unique label for each ground action and identify transitions induced by the same actions on different states with the same label. These labels are primarily used to distinguish applicable actions in a given state so that a much smaller, sufficient, set of labels may be attained.

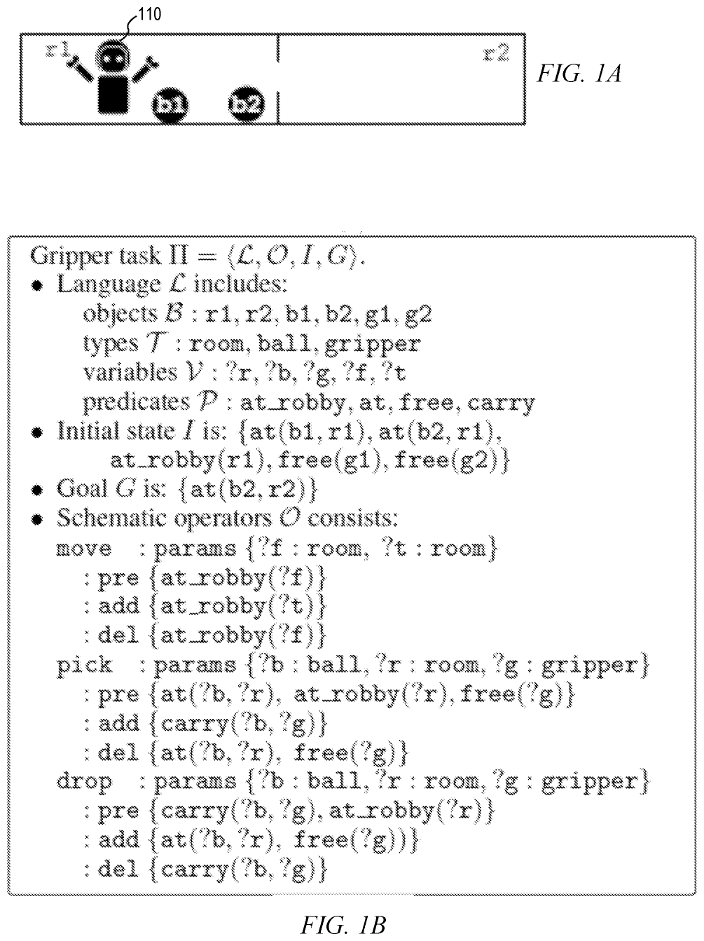

For example, consider a gripper domain where a robot moves balls between two rooms. FIGS. 1A and 1B depict the PDDL task in this domain, which will be used as a running example in this description. In FIG. 1A a graphical depiction of the PDDL task is shown. In FIG. 1B, a PDDL representation of the AI Planning task is shown. As shown in FIG. 1A, the robot (robby) 110 which has two grippers g1 and g2, is either in one of two rooms r1 and r2. In addition, two balls b1 and b2 are also either in room r1 or room r2. The robot 110, and thus the grippers g1 and g2, and the balls b1 and b2 can only be in one room or the other and cannot exist in both rooms at the same time. Assume that the AI Planning task, or goal G, is to move the ball b2 to room r2 using the robot 110. The PDDL representation of this AI Planning task in FIG. 1B defines the language L, initial state I, the goal G, and the schematic operators O, where the schematic operators O (also referred to as “actions”) include parameters (params), preconditions (pre), additions (add) and deletions (del).

Consider the schematic operator (or action) “pick” and its second parameter “?r:room”. All applicable groundings (specific instances) of the operator “pick” in any given state will have the same value for ?r, i.e., the current room the robot is in, i.e., if the robot is in room 2, the ?r will be room 2 and if the robot is in room 2, the ?r will be room 2. Therefore, this parameter is not essential for distinguishing LTS transitions. Note that it does not mean that the parameter can be omitted from the schematic operator, as it is essential for defining operator preconditions. On the label transition system (LTS), however, all labels of the corresponding grounded actions that differ only in the room parameter can be safely collapsed into one label, achieving a smaller set of labels.

It is no coincidence that discrete action sets of smaller sizes are also favored by reinforcement learning (RL) approaches. Choosing from a large collection of mostly irrelevant actions in a state can be detrimental to model-free methods. Most RL benchmarks have only a small number of actions, e.g., Atari benchmarks have at most 28 actions, representing all possible transition labels. When planning problems are case as Markov Decision Processes (MDPs), great care is taken in defining small label sets. In PDDLGym, the label sets are manually crated by identifying a subset of lifted schematic operator parameters that are inessential for distinguishing two labels in a state. For example, the ?r:room parameter from the gripper example in FIGS. 1A and 1B is manually identified as inessential.

In accordance with one aspect of the illustrative embodiments, an automated improved computing tool and improved computing tool functionality is provided for reducing action labels in AI Planning domains. With these improved mechanisms, a valid label reduction is defined for such AI Planning tasks and mechanisms for automatically obtaining this reduction are provided. The illustrative embodiments use lifted mutex groups to automatically identify the inessential parameters of the operators in an effective manner. As the term is used herein, a “mutex group” is defined as a set of operators out of which, maximally, one can be validly applied in any reachable state of objects involved in a computerized decision making process. The operators that form a mutex group are pairwise mutex. A mutex and a mutex group are both defined as invariants with respect to all states reachable from the initial state by a sequence of operators.

The illustrative embodiments define a parameter seed set and solve the AI Planning task by translating the task into a delete free planning task to thereby obtain the valid label reduction. The illustrative embodiments achieve a significant reduction in action labels which provides significant improvement in both reinforcement learning applications and lifted successor generation at least by speeding up the time to generate applicable actions given a state of the particular system and the goal.

Before discussing the different aspects of the illustrative embodiments in more detail, it is first beneficial to have an understanding of the way in which a PDDL task is defined, what lifted mutex groups are, how the PDDL task as it is represented as a Markov Decision Process (MDP), and how an AI Planning task may be handled by the use of lifted successor generation, each of which will be referenced in the description of the illustrative embodiments.

With regard to the definition of the PDDL task, a normalized PDDL task Π=(L, O, I, G) is defined over a first order language L, a finite set of schematic operators O, an initial state specification I, and a goal specification G (note that the term operator and action may be used interchangeably herein). A first order language L (B, T, V, P) includes a finite number of objects (B), types (T), variables (V), and fluent predicates (P). The association between types and objects is defined by a function D: T→2^{B}. T contains a special default type to. Every object is associated with this default type such that D(t₀)=B. Every pair of types tᵢ,tⱼ∈T satisfy one of the following conditions, either D(tᵢ)⊆D(tⱼ) or D(tᵢ)⊇D(tⱼ) or D(tᵢ)∩D(tⱼ)=0. V is a finite set of variable symbols such that each variable is associated with a type in T. All variables are represented with a prefix “?”, for example ?v. A pair of object and variable (o, ?v) are considered compatible if o∈D(tᵥ), where tᵥ is the type of variable v. A predicate in P has fixed arity and each argument is associated with a type in T. An atom is a predicate symbol followed by a parenthesized list of arguments, e.g., predicate (term1, term2, . . . ). For an atom α, free(α)∈V denotes a set of variables in the atom. If free(α)=0, then a is called a ground atom; otherwise it is called a lifted atom. A lifted atom is grounded by replacing the variable with a compatible object. If lifted atoms α and α′ have the same predict and the types of all the terms in α are subsets of types of respective terms in α′, then it is said that a is a subset of α′. That is, p(?a, ?b)⊆(?a′, ?b′) if D(tₐ)⊆D(tₐ′) and D(t_{b})⊆D(t_{b}′).

The initial state specification I is a conjunction of ground atoms with fluent predicates. The goal specification is a conjunction of ground atoms or their negations. A schematic operator o=(head, pre, add, del) in O includes the atom head(o), indicating the name and the parameters of the operator, the preconditions pre(o), the add-effects add(o), and the delete effects del(o), each being a conjunction of literals over L. For each operator o, the set of operator parameters params(o) is defined as free(pre(o))∪free(add(o))∪free(del(o)). Operators with empty parameter sets are called ground operators. Otherwise, an operator can be grounded by replacing parameters with compatible objects in the domain.

The set of all ground operators is denoted by O_{↓}. By o_{↓}(P/θ) what is denoted is a set of ground operators induced by assigning objects θ to parameter subset P and grounding the remaining parameters with all the compatible objects. In the gripper example shown in FIGS. 1A and 1, the ground operator set of the schematic operator o=pick(?b, ?r, ?g) induced by assignment {?b/b1, ?g/g1} is o_{↓}({?b/b1, ?g/g1})={pick(b1, r1, g1), pick (b1, r2, g1)}, where the parameters ?b and ?g are replaced with the objects mentioned in the assignment but the parameter ?r is replaced with all room objects, {r1, r2}.

A state s assigns values True and False to all ground atoms with fluent predicates. The initial state so of the task assigns value True to all atoms occurring in I, and False to all other fluent ground atoms. A ground operator o is applicable in state s if s|=pre(o), i.e., the preconditions of o are satisfied in the state s. A ground atom α is True in the successor state if and only if either it has been True in s and a∉del(o) or α∈add(o). A plan for the task is a sequence of ground operators whose subsequent application leads from so to some state s* with s*|=G.

With regard to lifted mutex groups, a mutex group is a set of mutually exclusive ground predicates M, of which the states s reachable from the initial state I can have at most one True state. That is ∀s, |M∩s|≤1, or equivalently ∀s, |{α|s|=α, α∈M}|≤1. For example, in the gripper example of FIGS. 1A and 1B, {at(b1, r1), at (b1, r2)} is a mutex group as, in any given state, the ball b1 can only be in one of the rooms r1 and r2. Any subset of a mutex group is also a mutex group. A lifted mutex group (LTG) is a set of lifted predicates that produces a mutex group when grounded. Formally, a lifted mutex group (LTG) is defined using an invariant candidate, which is a tuple c=(v^{f}, v^{c}, A) where v^{f}(c) is a finite set of fixed variables, v^{c}(c) is a finite set of counted variables, and A(c) is a finite set of atoms such that all the variables of the atoms are present in either v^{f}(c) or v^{c}(c), i.e. free(A(c))=v^{f}(c)∪v^{c}(c) and v^{f}(c)∩v^{c}(c)=0. For example, consider an invariant candidate c=({?b}, {?r}, {at(?b, ?r)}). Different groundings of fixed variables v^{f}(c)={?b} generate different sets of ground atoms and different grounding of counted variable v^{c}(c)={?r} generates ground atoms within each set, where ground atoms are represented by 1. One of the ground atom sets for {?b/b1} is c (?b/b1)={at(b1, r1), at (b1, r2)} and another ground set for {?b/b2} is c_{↓}(?b/b2)={at(b2, r1), at (b2, r2)}.

An invariant candidate is called a lifted mutex group (LMG) if all of its ground atom sets are mutex groups, i.e., ∀x, s, |{α|s|=α, α∈c_{↓}(v^{f}(c)/x)}|≤1. An LMG with no fixed variable can only generate on ground mutex group. For example, (0, ?r, {at_robby(?r)}) only induces ground atoms set {at_robby(r1), at_robby(r2)}. Since an LMG with multiple atoms can be split into multiple LMGs with a single atom each, for simplicity, it will be assumed herein that each LMG has only one atom.

With regard to the PDDL task being represented as a MDP, an MDP [symbol] =(S, A, P, R) contains a set of states S, a set of actions A, a transition probability distribution P: S×S×A→+[0, 2], and a reward function R: S→ [symbol] . When a PDDL task Π is cast as an MDP [symbol] , the states S∈ [symbol] are defined as the set of all states reachable from the initial states I of Π, the action set A∈ [symbol] is defined as the set of labels L that is composed of a unique label for each of the ground operators, the probability distribution P is defined to respect the state-transition in the PDDL operators, and the reward function R is defined as some positive integer where s|=G. In practices, for each of the ground operators, the head of the ground operator head(o) is assigned as the unique label.

With regard to the lifted successor generation solution to a PDDL defined AI Planning task, lifted successor generation works directly on a lifted level to generate successor states using database techniques. With a lifted successor generator solver, a state is represented as a database. Each predicate has a table with the number of columns according to the predicate arity. Each fact in the state forms a row in the table. With this state representation, the task of identifying applicable actions is equivalent to a database join query evaluation. Consider a planning task H=(L, O, I, G) over a first order language L=(B, T, V, P). A state s is a database D(s)=(B, {R_{P,s}|P∈P with objects B as domain and finite set of relations over these objects. The relation R_{P,s} contains all the ground atoms of predicate P in state s as tuples. The set of applicable actions in s actions for a schematic operator o∈O is identified by the conjunctive query Q(params(o)):-R_{P1,s}, . . . , R_{Pn,s} where Pi∈pre(o).

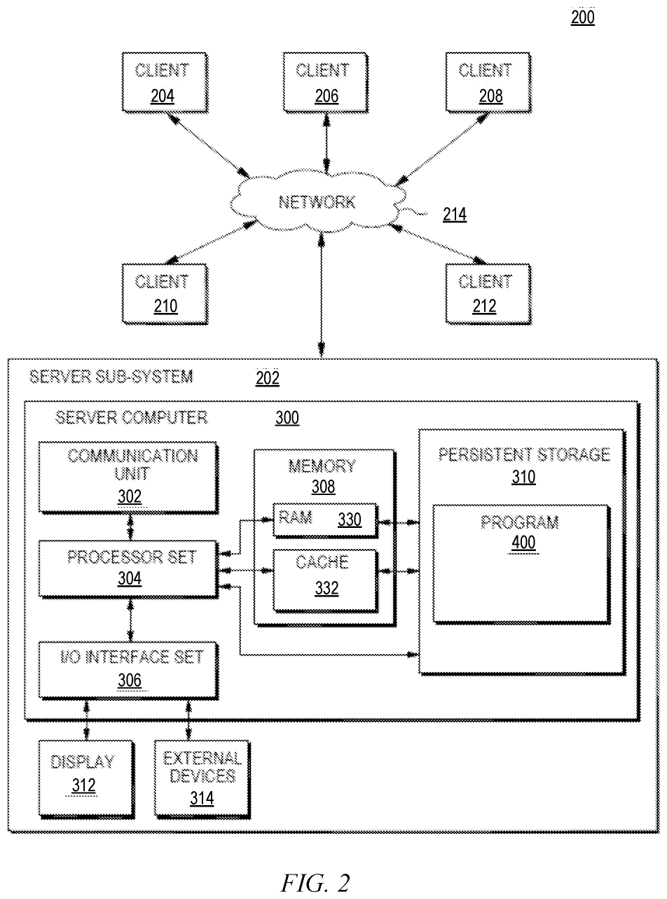

Having set forth the above, the present description will now discuss in more detail the improvements in label reduction and lifted successor generation for solving AI Planning tasks provided by the improved computing tool and improved computing tool functionality of the illustrative embodiments. As the present invention is specifically directed to an automated improved computing tool which may be provided as a computing system or as part of a computing system, FIG. 2 is provided an example block diagram of one illustrative embodiment of a computing system which may be specifically configured to implement the mechanisms of the illustrative embodiments.

As shown in FIG. 2, networked computers system 200 is an embodiment of a hardware and software environment for use with various illustrative embodiments of the present invention. Networked computers system 200 includes: server subsystem 202 (sometimes herein referred to, more simply, as subsystem 202); client subsystems 204, 206, 208, 210, 212; and communication network 214. Server subsystem 202 includes: server computer 300; communication unit 302; processor set 304; input/output (I/O) interface set 306; memory 308; persistent storage 310; display 312; external device(s) 314; random access memory (RAM) 330; cache 332; and program 400.

Subsystem 202 may be a laptop computer, tablet computer, netbook computer, personal computer (PC), a desktop computer, a personal digital assistant (PDA), a smart phone, or any other type of computer (see definition of “computer” in Definitions section, below). Program 400 is a collection of machine readable instructions and/or data that is used to create, manage and control certain software functions that will be discussed in detail herein below.

Subsystem 202 is capable of communicating with other computer subsystems via communication network 214. Network 214 can be, for example, a local area network (LAN), a wide area network (WAN) such as the internet, or a combination of the two, and can include wired, wireless, or fiber optic connections. In general, network 214 can be any combination of connections and protocols that will support communications between server and client subsystems.

Subsystem 202 is shown as a block diagram with many double arrows. These double arrows (no separate reference numerals) represent a communications fabric, which provides communications between various components of subsystem 202. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 308 and persistent storage 310 are computer-readable storage media. In general, memory 308 can include any suitable volatile or non-volatile computer-readable storage media. It is further noted that, now and/or in the near future: (i) external device(s) 314 may be able to supply, some or all, memory for subsystem 202; and/or (ii) devices external to subsystem 202 may be able to provide memory for subsystem 202. Both memory 308 and persistent storage 310: (i) store data in a manner that is less transient than a signal in transit; and (ii) store data on a tangible medium (such as magnetic or optical domains). In this embodiment, memory 308 is volatile storage, while persistent storage 310 provides nonvolatile storage. The media used by persistent storage 310 may also be removable. For example, a removable hard drive may be used for persistent storage 310. Other examples include optical and magnetic disks, thumb drives, and smart cards that are inserted into a drive for transfer onto another computer-readable storage medium that is also part of persistent storage 310.

Communications unit 302 provides for communications with other data processing systems or devices external to subsystem 202. In these examples, communications unit 302 includes one or more network interface cards. Communications unit 302 may provide communications through the use of either or both physical and wireless communications links. Any software modules discussed herein may be downloaded to a persistent storage device (such as persistent storage 310) through a communications unit (such as communications unit 302).

I/O interface set 306 allows for input and output of data with other devices that may be connected locally in data communication with server computer 300. For example, I/O interface set 306 provides a connection to external device set 314. External device set 314 will typically include devices such as a keyboard, keypad, a touch screen, and/or some other suitable input device. External device set 314 can also include portable computer-readable storage media such as, for example, thumb drives, portable optical or magnetic disks, and memory cards. Software and data used to practice illustrative embodiments of the present invention, for example, program 400, can be stored on such portable computer-readable storage media. I/O interface set 306 also connects in data communication with display 312. Display 312 is a display device that provides a mechanism to display data to a user and may be, for example, a computer monitor or a smart phone display screen.

In this embodiment, program 400 is stored in persistent storage 310 for access and/or execution by one or more computer processors of processor set 304, usually through one or more memories of memory 308. It will be understood by those of skill in the art that program 400 may be stored in a more highly distributed manner during its run time and/or when it is not running. Program 400 may include both machine readable and performable instructions and/or substantive data (that is, the type of data stored in a database). In this particular embodiment, persistent storage 310 includes a magnetic hard disk drive. To name some possible variations, persistent storage 310 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

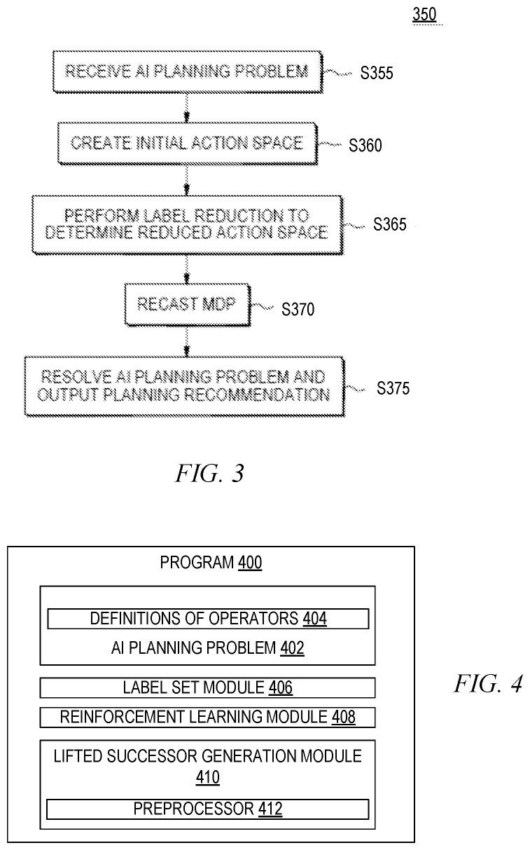

As shown in FIG. 2, networked computers system 200 is an environment in which an example method according to the present invention can be performed. As shown in FIG. 3, flowchart 350 shows an example method according to one or more of the illustrative embodiments of the present invention. As shown in FIG. 4, program 400 performs or control performance of at least some of the method operations of flowchart 350. This method and associated software will now be discussed, over the course of the following paragraphs, with extensive reference to the blocks of FIGS. 2, 3 and 4.

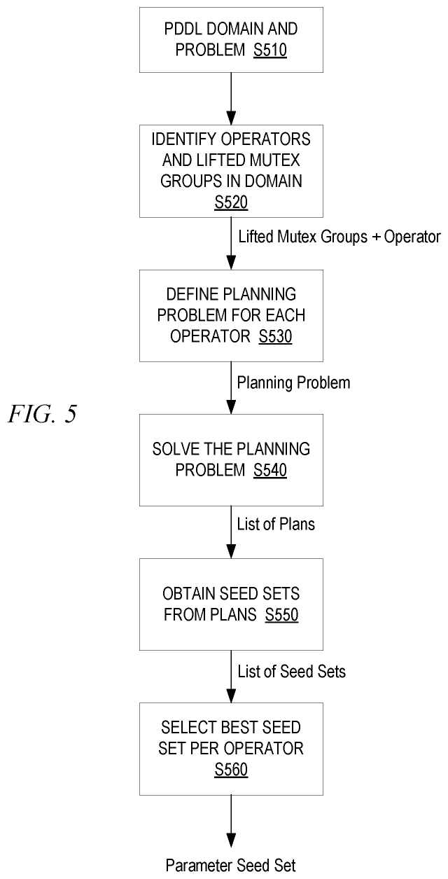

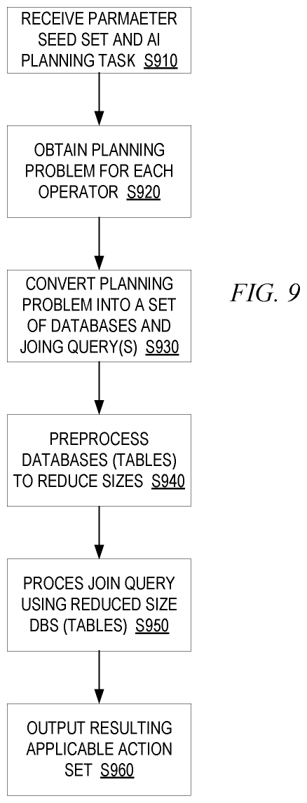

FIG. 3, and FIGS. 5 and 9 thereafter, present flowcharts outlining example operations of elements of the present invention with regard to one or more illustrative embodiments. It should be appreciated that the operations outlined in these figures are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in these figures, and may, in some cases, make use of the results generated as a consequence of the operations set forth in these figures, the operations in FIGS. 3, 5, and 9 themselves are specifically performed by the improved computing tool in an automated manner.

As shown in FIG. 3, processing begins at operation S355, where domain-dependent artificial intelligence planning problem 402 is received. More specifically, what is meant by “domain-dependent” here is that the planning problem is described in a domain-independent language (such as PDDL), but it is noted that a typical planning problem typically encodes a sequential decision making problem for a particular domain. Some examples are as follows: transportation logistics problems, elevators high-level operation, greenhouse logistics operation, spacecraft operation, and genetics related computation. Domain-dependent artificial intelligence (AI) planning problem 402 comprises definitions for a plurality of operators 404. It is noted that a label reduction will be valid if, and only if, it is directed to distinct labels to any two operators that can be applied in every reachable state. It is noted that the information included in domain-dependent artificial intelligence planning problem 402 does not need to be received at the same time or from the same informational source.

Processing proceeds to operation S360, where label set module (“mod”) 306 creates an initial version of a label set, which defines an initial version of an action space, with the label set including a plurality of labels, and with each label of the plurality of labels respectively corresponding to the operators of the plurality of operators 404.

Processing proceeds to operation S365, where label set module 406 performs, automatically and by machine logic, a label reduction on the initial version of the label set to obtain a reduced version of the label set that defines a reduced action space. As discussed in detail hereafter, this label reduction may involve the determination and use of mutex groups and lifted mutex groups corresponding to the operators, as discussed previously.

Processing proceeds to operation S370, where reinforcement learning mod 408 recasts the AI planning problem 402 as a first Markov Decision Process (MDP) using the reduced version of the label set.

Processing proceeds to operation S375, where reinforcement learning module 408 resolves the AI Planning problem to obtain a first planning recommendation by performing reinforcement learning using the discrete-time stochastic control process of the first Markov Decision Process using the reduced action space defined by the reduced version of the label set. As discussed hereafter, in some illustrative embodiments, the AI Planning problem solution may alternatively or in addition, utilize a lifted successor generation module 410 that operates based on the reduced label set, also referred to herein as a reduced action or operator set, to perform database join operations that identify the applicable actions for a given state and goal state of the AI Planning problem.

Some illustrative embodiments of the present invention recognize one, or more, of the following facts, potential problems and/or potential areas for improvement with respect to the current state of the art: (i) as the number of objects increases in the planning problem, the number of grounded operators, and thus actions in the relational MDP, also increases; (ii) the number of objects leads to a proliferation of permutations, which, in turn, leads to expensive computations and inefficient learning; (iii) to remedy the issue noted in the foregoing item, some known techniques have either generated the action label sets of MDP manually without using the PDDL operator set or have performed manual operator parameter reduction, eliminating the distinction between labels of some ground operators and using the reduced labels as MDP action set; (iv) PDDL operator encodes its applicability and transition dynamics as the precondition and effects, but MDP actions are mere labels and the transition dynamics are encoded by a transition function; and/or (v) this semantic difference potentially means that some of the parameters defined in PDDL operators turn out not to be essential for RL action labels, as discussed previously, i.e., these operators may be inessential.

Some illustrative embodiments of the present invention may include one, or more, of the following operations, features, characteristics and/or advantages: (i) an automated improved computing tool and improved computing tool functionality that performs a label reduction that includes leveraging methods for discovering lifted mutex groups; (ii) introduction of definitions of valid label reduction and applicable operator mutex groups, with the definitions showing the connection between the two; (iii) automatic derivation, by computer machine logic, of operator label reductions for planning tasks based on operator parameter reduction (in this aspect, the problem of obtaining a seed set of operator parameters is formally defined); (iv) solving the problem by: (a) translating the problem to delete-free planning terms, and (b) exploring the space of plans to obtain a seed set of high quality; and/or (v) significant reduction in operator labels, which translates into improved performance of standard RL agents on the tested problems.

A Reinforcement Learning (RL) problem is defined as a Markov Decision Process (MDP) that includes an associated set of states, set of actions, transition function, reward function, and discount factor. A planning definition language task is cast as an instance of an MDP with state space expressed in a language (that is, L) as a power set of predicates and constants, with the MDP including an action set as the set of grounded head atoms from the grounded operators, a transition function as a PDDL action simulator, and a reward function. The reward function is expressed as: (i) a positive real number when a goal specification is satisfied by the state; (ii) negative real number when the goal specification is not satisfied (or some variation thereof).

With regard to Operator Label Reduction (OLR, or, reducing an action space), a planning task can be represented as a labeled transition system (LTS) where labels are actions that can be executed in states. These transition labels are identified by the head(o) for the ground operator. For example, pick(b1, r1, g1) is a label for the operator that picks the ball b1 from room r1 in the gripper g1. A label set L consists of a unique label for each grounded operator in O_{↓}. The label set size increases exponentially in the number of objects. The illustrative embodiments reduce the size of the label set L at least by identifying an assignment of labels to planning operators such that it generates a smaller label set L′ while producing an equivalent transition system. This requirement is captured by specifying the criteria for a valid label reduction. A label reduction is valid if it assigns distinct labels to any two ground operators that can be applied in the same reachable state. For example, operators pick (b1, r1, g1) and pick(p2, r2, g1) cannot be applied in the same state as the gripper g1 cannot be in two different rooms in the same state. Thus, assigning the same label to both would be valid. But pick(b1, r1, g1) and pick(b2, r1, g2) can be applied in the same state, and hence, cannot be assigned the same action label. In other words, for each reduced label, the set of corresponding operators must include at most one applicable operator for each reachable state s. Such operator sets are called applicable operator mutex groups, or AOMGs.

A given set of operators may form an applicable operator mutex group (AOMG) for some reachable state s. Any subset of an AOMG is also an AOMG, and any subset of operators of size 2 is an AOMG. A partitioning of operators into AOMGs defines a valid operator label reduction, and vice versa, a valid operator label reduction defines a partitioning of operators into AOMGs. In order to find operator label reductions with as small as possible reduced label set size, operators are partitioned into a set of as few as possible AOMGs. A minimal set cover of size m can be greedily translated into an operator label reduction to a reduced set of labels of size m. Note that the minimal set cover would be done over the ground operator sets and their subsets and for larger planning problems may take a significant computational effort.

On the other hand, some illustrative embodiments of the present invention operate based on a different approach than that described in the previous paragraph. More specifically, the focus is on finding AOMGs via reduction of operator parameters. AOMGs are found separately for each lifted schematic operator. Removing some parameters from the schematic operator can provide an elegant way of finding pairwise non-intersecting AOMGs per schematic operator.

For example, consider a schematic operator o=pick(?b, ?r, ?g), as a robot can only be in one specific room in any state, only one specific assignment to ?r is satisfiable in any state. Thus, one possible set of AOMGs can be obtained by defining partial grounding of operator o on the subset of parameters obtained after removing ?r. That is, o_{↓}({?b/b, ?g/g})|∀b,g}={{pick(b1,r1,g1),pick(b1, r2, g1)}, {pick(b1, r1, g2), pick(b1,r2,g2)}, . . . }. A partial grounding of parameter subset (X⊆params(o)) of a schematic operator o induces sets of ground operators where each set corresponds to a particular assignment of objects to parameter subset X. Hence, one wants to identify a subset of parameters (X) such that any assignment (c) to this subset results in the ground operator set (o_{↓}(X/c)) being an AOMG, like the subset {?b, ?g} in the above example). Stated another way, any (partial) parameter grounding defines a partitioning over the set of (ground) operators, where each partition corresponds to a particular assignment of constants to a subset of parameters. Thus, it is sought to identify a subset of schematic operator parameters such that each grounding of these parameters is an AOMG. It is noted that lifted mutex groups (LMGs) have very similar properties in that any assignment to their fixed variables is a mutex group. Thus, lifted mutex groups (LMGs) can be used for finding a subset of schematic operator parameters that can be uniquely identified from an assignment to the other parameters.

That is, given a schematic operator o and a lifted mutex group l−v^{f}(l), v^{c}(l), {α}), if p⊆α for some p∈pre(o), then any assignment c to X=params(o)\v^{c}(l) results in o_{↓}(X/c) being an AOMG. An LMG is relevant to a schematic operator if an atom p in the precondition satisfies p⊆α, where α∈A(l). The parameters from set v^{c}(l) of a relevant LMG need not be included in X. Given the assignment to v^{f}(l)⊆params(o) the LMG l guarantees a unique assignment to parameters v^{c}(l). Once the assignment to these parameters (v^{f}(l)∪v^{c}(l)⊆params(o)) are identified, another LMG l′ may be used to identify the assignment to parameters v^{c}(l′) and hence v^{c}(l′) can also be removed from X. Essentially, the multiple LMGs may be leveraged to further reduce the subset X. Formally, this corresponds to the following problem which is referred to as the parameter seed set:
Input: A schematic operator o with parameters params(o) and a set of relevant lifted mutex groups L.
Find: A subset X⊆params(o) of parameters s.t. ∃X₁, . . . , Xₖ with (i) X=X₁⊆X₂⊆ . . . ⊆Xₖ=parameters(o), and (ii) Xᵢ₊₁=Xᵢ∪v^{c}(l) for some l∈L s.t. v^{f}(l)⊆Xᵢ.
   Any assignment of objects to the parameter seed set X will result in a unique assignment to all the remaining parameters of o for any reachable state. Different parameter seed sets X correspond to different AOMGs. To find the smallest possible label set L′, the number of AOMGs are to be minimized and therefore, a seed set X with a minimum possible total number of assignments is utilized. This can be expressed as [symbol] Π_{x∈X}|D(x)|. As the objective is not linear, an equivalent tone can be used instead: [symbol] Σ_{x∈X}log(|D(x)|).

The parameter seed set problem is NP-Complete. To solve the parameter seed set problem, it is a case considered a (delete-free) STRIPS planning task with action costs. The set L of relevant LMGs is first found and then, for each schematic operator o, a separate planning task is defined as Πₒ=(Lₒ, Oₒ, Iₒ, Gₒ) where:
Language Lₒ contains a single predicate mark and an object for each parameter in params(o);
The set Oₒ consists of two types of operators:
a. seedₓ operators are defined for each parameter x∈params(o) as seedₓ (seedₓ, 0, {mark(x)}, 0, log(|D(x)|)); and
b. getₗ operators are defined for each relevant LMG l as getₗ:-(getₗ, {mark(x)|x∈v^{f}(l)}, {mark(y)|y∈v^{c}(l), 0, 0);
Initial state Jo=0; and
Goal state Go—{mark(x)|∀x∈params(o)}.
   The operator seedₓ marks parameter x∈params(o) as an element of the seed set. Operator getₗ indicates that a unique assignment for the parameters x∈v^{c}(l) can be identified if all parameters y∈v^{f}(l) are known. Therefore, the parameters v^{c}(l) can be reduced. A plan for Πₒ corresponds to a sequence of seed and getₗ operators. The parameters marked by seed operators form the seed set, while others are reduced.

The cost of a plan π is Σ_{seed}_{ₓ}_{∈π} log (|D(x)|), and therefore, a cost-optimal plan will correspond to a parameter seed set with a minimal possible total number of assignments. To summarize, a parameter seed-set X is found for each schematic operator such that assigning objects to X will result in a set of ground operators that is an AOMG. Hence, all the ground operators in that set can be assigned the same label. This reduces the size of the label set L.

Thus, some illustrative embodiments of the present invention may include one, or more, of the following characteristics, features, advantages and/or operations: (i) evaluates the advantage of reducing the action label set size by casting the PDDL task as an MDP with the reduced label set and learning an RL policy; (ii) because the objective is to evaluate the reduction of the action space, and not evaluation of the generalization of policies, the number of objects in each domain is fixed; (iii) uses a pre-existing PDDL library (for example, PDDLEnv4) to convert the PDDL domain and problem files to RL Environment; (iv) uses a domain-independent planning heuristic as a dense reward function for training purposes; (v) employs a Doubling DQN implementation from an ACME RL library to learn a state-action value function; (vi) applies a greedy policy; (vii) uses hyperparameters in the domains; (viii) 500 unique PDDL problem files were randomly generated; (ix) in experimental use, reduction of action labels was found to improve the sample efficiency by as many as 300,000 steps; (x) in blocks and logistics domains that are not able to learn a policy, become able to learn a policy once a reduced label set is used (that is, training becomes feasible where it previously was not); and/or (xi) reducing the action label set yields significant gain in terms of sample efficiency.

Some illustrative embodiments of the present invention may include one, or more, of the following characteristics, features, advantages and/or operations: (i) can be used for problem files, subjected to RL evaluation, that are considered as minuscule in planning terms, but these problems have sparse rewards and are difficult for RL agents to solve; (ii) even in such small-scale problems, where there are not too many labels to begin with and the reduction is not large in absolute terms, reducing the action labels is advantageous; and/or (iii) in large domains, with many objects, various illustrative embodiments of the present invention can potentially provide tremendous leverage for training RL algorithms.

Some illustrative embodiments use definitions of valid label reduction and applicable operator mutex groups in performing label reduction. Some illustrative embodiments are directed to a method for automatically deriving operator label reductions for planning tasks based on operator parameter reduction. For that, a parameter seed set problem may be introduced, and a solution to the problem can be suggested by translating it to delete-free planning. Some illustrative embodiments can facilitate a significant reduction in operator labels, across all planning domains. This reduction can translate into improved performance of standard RL agents, e.g., AI computer models implementing reinforcement learning (RL) to learn how to solve various problems, e.g., in robotics, automated vehicles, and the like.

FIG. 5 is an example flow diagram illustrating an operation for generating a parameter seed set, or seed actions/operators, in accordance with one illustrative embodiment. The operation shown in FIG. 5 may be implemented, for example, as part of the operation of step S365 in FIG. 3 and implemented in program 400 of FIG. 4, such as in label set module 406. As shown in FIG. 5, the operation starts by receiving a PDDL defined AI Planning problem in step S510. The schematic operators and lifted mutex groups (LMGs) are identified in step S520. The planning problem is then defined for each operator in terms of the LMGs for the operators in step S530. The planning problem is solved to generate a list of plans in step S540. In step S550 the seed sets are obtained from the plans which are then used to select the best seed set per operator in step S560, i.e., the seed set X that provides the minimum number of assignments and thus, a minimum number of AOMGs, e.g., [symbol] Π_{x∈X}|D(x)|, or as the objective is not linear, the following can be used instead [symbol] Π_{x∈X}log (x)|).

In view of the above, it can be seen that using lifted mutex groups (LMGs), one can reduce the action space from an initial action space to a set of seed actions having exclusivity properties such that if a seed action is true, other actions from the same set are not true. By identifying the seed actions as LMGs and redefining the MDP representation of the AI Planning Problem in terms of these LMGs, on can resolve the AI Planning problem and output an AI planning recommendation in a more efficient manner as the large set of actions in the initial action space need not be considered and instead only the reduced action space need be considered.

In accordance with a further aspect of the illustrative embodiments, the mechanisms described above may be implemented to generate a parameter seed set, or seed actions/operators, which may be used to assist in performing lifted successor generation solutions for AI Planning tasks by specifically reducing the size of the data structures used to perform the lifted successor generation solutions. That is, in addition to improving RL based solutions to AI Planning tasks, such as may be implemented in the RL module 408 in FIG. 4, the illustrative embodiments may also be used to improve lifted successor generation solutions to such AI Planning tasks that are defined in terms of PDDL specifications, such as in the lifted successor generation module 410 in FIG. 4.

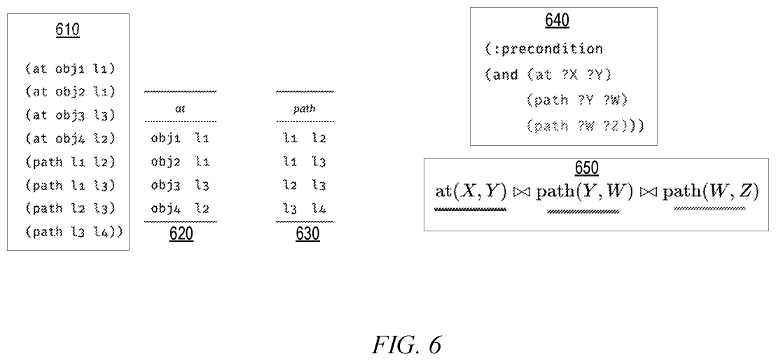

Lifted successor generation finds a set of applicable ground actions in the given state by treating the state as a database and formulating a join query from lifted action preconditions. For example, FIG. 6 shows an example of a set of states 510 and their corresponding databases 620 and 630, or tables of a database. For example, the state (at obj1 l1) indicates that, as an initial state, object 1 is at location l1. Similarly, the state (path 1112) sets forth an initial state that there is a path from location l1 to location l2. These states 610 may specify an initial set of states. For each type of state, e.g., “at” and “path”, a corresponding database 620 and 630 is generated where entries in the database comprise the parameters associated with that state type. For example, the database “at” 620 comprises entries having the object and location specified. The database “path” 630 has the parameters of the starting location and destination location specified.

Having represented the states as databases 620 and 630, or tables of a database, applicable actions may be identified by performing a database join query on the defined databases (tables) 620 and 630. Thus, for example, a database join query 640 may be used to evaluate applicable actions and may be processed as shown in 650, i.e., at(X, Y) joined with path(Y, W) and joined with path(W, Z).

The join query evaluation provides tuples of object assignments to the action parameters, which define the ground actions that are applicable in the state. There are several possible ways of exploiting the additional information of the seed parameters for accelerating database join query operations used to perform lifted successor generation solutions to AI Planning tasks. The complexity of the join query evaluation is measure din terms of the input and output size of the join query. With the reduced set of parameters (seed set), the input and output of the join query can be modified and improvement can be achieved in computation time. To modify the output, the solution can query only for the seed parameters and derive the assignments for non-seed parameters using the sequence of lifted mutex groups (LMGs).

In some illustrative embodiments, this solution involves a preprocessor 412 (in FIG. 4) of a lifted successor generation module 410, that preprocesses the database tables used in the join query operations and thus, the input size of the join query is modified. In these illustrative embodiments, a pre-join of the precondition tables is performed with the corresponding lifted mutex group table, over non-seed parameters. This allows the solution to reduce the size of the tables used to process the join query which improves join query processing performance. It should be noted that this does not modify the existing query evaluation process.

That is, in some illustrative embodiments, the preprocessor processes the database table(s) to modify the join query processing by reducing the table rows, but keeping the same number of join operations performed. In these illustrative embodiments, for each combination of assigned objects to seed parameters, the object assignments to non-seed parameters, i.e., uniquely identified parameters, are identified. Thereafter, the database table(s) are filtered according to the object assignments identified. That is, the rows in the table(s) that have non-seed parameters can be reduced by removing rows with the non-seed parameters. In some illustrative embodiments, to filter the rows, a join (or merge) of the table with an LMG table is performed. For example, at(?truck, ?loc) is an LMG because any truck can only be at one location at any given time. Thus, the “at” table will have only two rows (given that there are only 2 trucks in the domain). So, when the location(?from) table is joined with the at(?truck, ?location) table where ?from==?location, the location table will only be left with 2 rows.

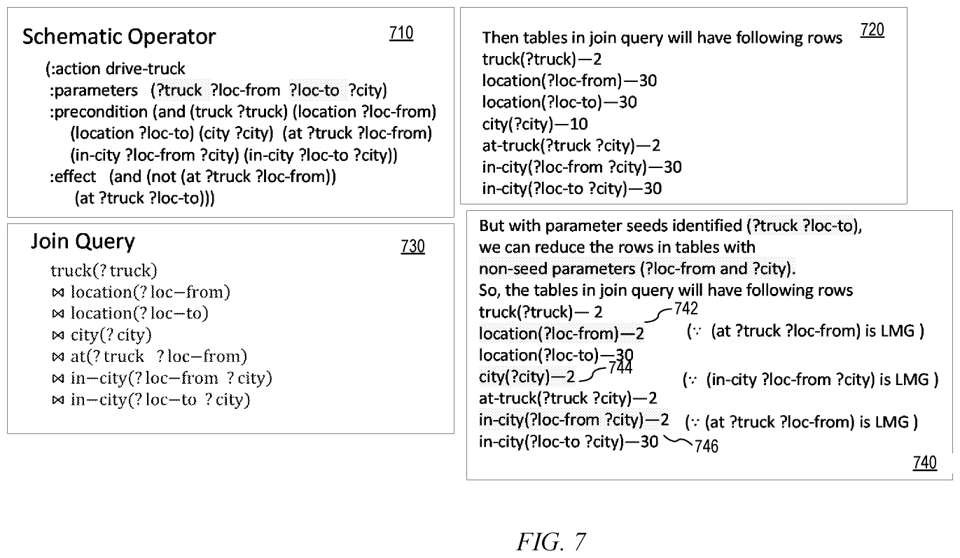

An example of this reduction in the size of the database tables used to perform the join operations for a lifted successor generation module 410 is shown in FIG. 7. In the example of FIG. 7, it is assumed that, in a logistics domain, there are 2 trucks, 10 cities, and 30 locations (3 in each city). It is further assumed that a truck cannot exist in more than one location at the same time, thus, the truck cannot be in both a first city (of the 10 cities) and a second city (of the 10 cities) or a first location (of the 30 locations) and a second location (of the 30 locations) at the same time.

A schematic operator for the AI Planning task, as specified in PDDL, may be of the type shown in 710, where the schematic operator “drive-truck” may have the parameters ?truck, ?loc-from, ?loc-to, and ?city. A separate table may be generated for each of various states, e.g., truck(?truck), location(?loc-from), location(?loc-to), city(?city), at-truck(?truck ?city), in-city(?loc-from ?city), and in-city(?loc-to ?city). As shown in FIG. 7, in element 720, each of these tables have the corresponding number of rows. The database join query for the schematic operator in 710 is shown as element 730 and shows that the join query comprises performing join operations of the table truck(?truck) with each of the other tables shown in element 720.

However, if one uses the mechanisms of the illustrative embodiments discussed above to identify a parameter seed set, then one can determine that the parameter seed set comprises the parameters ?truck and ?loc-to, meaning that the non-seed parameters are ?loc-from and ?city. Thus, the lifted mutex group (LMG) may comprise the parameters ?truck and ?loc-to, which may then be applied to filter the rows of the various tables in element 720 and reduce the size of tables that have non-seed parameters, i.e., ?loc-from and ?city. That is, for those tables that have rows specifying the non-seed parameters, these rows may be removed such that the table size is reduced to only a number of rows corresponding to rows referencing the seed parameters ?truck and ?loc-to. Thus, as shown in element 740 of FIG. 7, the tables 742, 744, and 746 have their sizes reduced from 30 rows, 10 rows, and 30 rows, to 2 rows each, corresponding to the two seed parameters ?truck and ?loc-to.

Once the size of the tables is reduced, the join operation may be performed to obtain the list of applicable actions which may be used to solve the AI planning task. That is, a plan is identified that starts from an initial state and achieves a goal. For example, consider the initial state and goal in FIG. 1B. The plan would include a sequence of 3 applicable actions:
1. pickup(b1, g1, r1)—pick ball 1 from room 1 in gripper 1
2. move(r1, r2)—move robot from room1 to room2
3. drop(b1, g1, r2)—drop the ball 1 from gripper 1 in room2.
   To identify this plan, it is important to know what actions are applicable (possible) in the initial state. The illustrative embodiments provide a mechanism to determine these applicable actions.

Thus, by performing preprocessing by a preprocessor 412 of a lifted successor generation module 410, to thereby filter the table rows of the tables of a join operation based on the parameter seed set, the illustrative embodiments are able to minimize the amount of processing needed to complete the join query processing of the lifted successor generation solution. This will increase the speed by which the lifted successor generation solution is performed and make the AI Planning problem solution overall more efficient when identifying applicable actions given an initial state and a goal state.

In some illustrative embodiments, the preprocessor 412 may operate to reduce the number of join operations that need to be performed to perform the lifted successor generation solution to the AI Planning task. That is, rather than filtering tables to remove rows that have non-seed parameters, as in FIG. 7, the preprocessor may instead operate to remove tables with only non-seed parameters present. Alternatively, both filtering operations may be applied to the tables to remove rows that have non-seed parameters and to also remove tables with only non-seed parameters present.

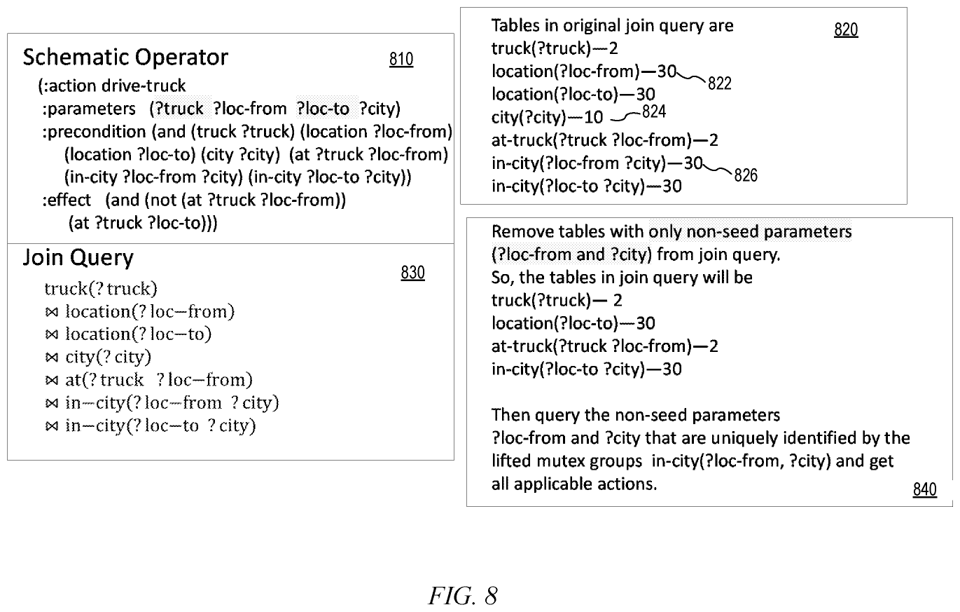

An example of a preprocessor operation to remove tables having only non-seed parameters, in accordance with one illustrative embodiment, is shown in FIG. 8. The illustrative embodiment shown in FIG. 8 is similar to that of FIG. 7 with similar problem definition, similar schematic operator 810, similar tables 820, and similar join query 830. However, as shown in element 840, rather than having the same number of tables as in element 820, the preprocessor operates to remove tables with only non-seed parameters, i.e., (?loc-from and ?city) in this example, from the join query processing. In this example, the tables location(?loc-from), city(?city), and in-city(?loc-from ?city), i.e., tables 822-826 all have only the non-seed parameters. Hence, removing these tables from the join query processing, the resulting reduced set of tables comprises the tables 840.

Having filtered the tables to obtain the reduced set of tables 840, the non-seed parameters ?loc-from and ?city, which are uniquely identified by the lifted mutex groups (LMGs) in-city(?loc-from, ?city) are queried and all applicable actions are obtained.

Thus, the parameter seed set, or seed actions, identified through the first aspect of the illustrative embodiments described above may be used as a basis for improving the operation of a join query processing performed in the lifted successor generation module 410 for solving an AI Planning task. The illustrative embodiments may provide a preprocessor 412 that preprocesses the tables to reduce their size and thereby improve the efficiency and speed by which the lifted successor generation module 410 operates to generate applicable actions for the AI Planning task. The applicable actions for the AI Planning task may then be used to perform AI operations, such as controlling an autonomous vehicle, controlling a robot, identifying operations that an AI computer model may evaluate for generating decision making support outputs, such as recommendations, predictions, classifications, and the like.

FIG. 9 is a flowchart outlining an example operation for improving a lifted successor generation solution to an AI Planning task in accordance with one illustrative embodiment. As shown in FIG. 9, the operation assumes the identification of a parameter seed set, or seed actions, such as may be generated through the process shown in FIG. 5, for example. The parameter seed set is received along with the AI Planning task definition, such as may be provided in a PDDL format in step S910. The planning problem for each operator is obtained in step S920, which may obtain these planning problems from step S530 of FIG. 5. Thereafter, the planning problem is converted to a set of databases or tables, and a database join query in step S930. The generated databases/tables are then preprocessed by a lifted successor generation module preprocessor, based on the parameter seed set and lifted mutex groups (LMGs), to reduce the size of data structures processed to perform the join query processing in step S940. This pre-processing may include filtering out rows of tables that have non-seed parameters, or filtering out tables that have only non-seed parameters, as discussed previously with regard to FIGS. 7 and 8. The resulting data structures after the pre-processing is performed, may then be used to perform the join query processing in step S950. For example, with the table row filtering of FIG. 7, the join query processing may proceed as normal but with the reduced size tables. For the table removal filtering of FIG. 8, the join query of the non-seed parameters by the lifted mutex groups may be performed to obtain the applicable actions. The resulting set of applicable actions may then be output in step S960 for further use as a result of the AI Planning task.

The present invention may be a specifically configured computing system, such as server subsystem 202 or server computer 300, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides improved efficiency and speed of performance of AI Planning tasks by providing mechanisms that minimize the action set needing to be considered to solve the AI Planning tasks to only a seed set and, in some illustrative embodiments, improving the solution of such AI Planning tasks performed by lifted successor generation specifically by reducing the size of the data structures required to generate the solution and identify the applicable actions for a given state need to reach a goal state. The improved computing tool implements mechanism and functionality, such as the program 400 in FIG. 4 which specifically configures the server computer 300 and/or server subsystem 202 to implement the particular improved computer functionality described herein, which cannot be practically performed by human beings either outside of, or with the assistance of, a technical environment, such as a mental process or the like. The improved computing tool provides a practical application of the methodology at least in that the improved computing tool is able to increase the speed and efficiency of AI Planning task solutions which are a basis for decision making in various domains including autonomous vehicle control, robotic controls, and the like.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described illustrative embodiments. The embodiment was chosen and described in order to best explain the principles of the invention, the practical application, and to enable others of ordinary skill in the art to understand the invention for various illustrative embodiments with various modifications as are suited to the particular use contemplated. The terminology used herein was chosen to best explain the principles of the illustrative embodiments, the practical application or technical improvement over technologies found in the marketplace, or to enable others of ordinary skill in the art to understand the illustrative embodiments disclosed herein.

What is claimed is:

1. A computer-implemented method comprising:
receiving an artificial intelligence (AI) planning problem including definitions for a plurality of operators;
creating an initial version of a label set, which defines an initial version of an action space, with the label set including a plurality of labels, and with each label of the plurality of labels respectively corresponding to the operators of the plurality of operators;
performing, automatically and by machine logic, a label reduction on the initial version of the label set to obtain a reduced version of the label set that defines a reduced action space, wherein the reduced version of the label set is a seed set;
representing the AI planning problem as a lifted successor generation problem comprising a set of tables and at least one join query on the set of tables;
executing a lifted successor generation module on the lifted successor generation problem using the seed set to process the at least one join query and generate one or more applicable actions as a solution to the AI planning problem; and
outputting the one or more applicable actions for the AI planning problem for further AI operations.

2. The computer-implemented method of claim 1, wherein executing the lifted successor generation module comprises executing a preprocessor of the lifted successor generation module to preprocess the set of tables to reduce a size of the set of tables prior to processing the at least one join query.

3. The computer-implemented method of claim 2, wherein the preprocessor preprocesses the set of tables to remove one or more rows of one or more of the tables in the set of tables that have non-seed set labels in elements of the one or more rows.

4. The computer-implemented method of claim 2, wherein the preprocessor preprocesses the set of tables to remove one or more tables in the set of tables that have only non-seed set labels in the elements of the one or more tables.

5. The computer-implemented method of claim 1, wherein performing the label reduction comprises:
generating, by machine logic, a mutex group of operators from the plurality of operators; and
executing, by the machine logic, the label reduction operation using the mutex group of operators to reduce a number of labels, present in the reduced version of the action space, relative to a number of labels in the original version of the action space.

6. The computer-implemented method of claim 5, wherein executing the label reduction operation comprises performing a partial ground of operators in the plurality of operators.

7. The computer-implemented method of claim 5, wherein the mutex group is a lifted mutex group, wherein a lifted mutex group is a set of lifted predicates that produces a mutex group when grounded.

8. The computer-implemented method of claim 1, wherein performing the label reduction on the initial version of the label set comprises identifying schematic operators and lifted mutex groups (LMGs) based on the initial version of the action space, and wherein representing the AI planning problem as a lifted successor generation problem comprising defining the AI planning problem, for each schematic operator, in terms of a subset of LMGs corresponding to the schematic operator.

9. The computer-implemented method of claim 1, further comprising:
generating one or more plans for solving the AI planning problem based on the one or more applicable actions in the output.

10. The computer-implemented method of claim 1, wherein the AI planning problem is defined in a Planning Domain Definition Language (PDDL) data structure.

11. A computer program product comprising a computer readable storage medium having a computer readable program stored therein, wherein the computer readable program, when executed on a data processing system, causes the data processing system to:
receive an artificial intelligence (AI) planning problem including definitions for a plurality of operators;
create an initial version of a label set, which defines an initial version of an action space, with the label set including a plurality of labels, and with each label of the plurality of labels respectively corresponding to the operators of the plurality of operators;
perform, automatically and by machine logic, a label reduction on the initial version of the label set to obtain a reduced version of the label set that defines a reduced action space, wherein the reduced version of the label set is a seed set;
represent the AI planning problem as a lifted successor generation problem comprising a set of tables and at least one join query on the set of tables;
execute a lifted successor generation module on the lifted successor generation problem using the seed set to process the at least one join query and generate one or more applicable actions as a solution to the AI planning problem; and
output the one or more applicable actions for the AI planning problem for further AI operations.

12. The computer program product of claim 11, wherein executing the lifted successor generation module comprises executing a preprocessor of the lifted successor generation module to preprocess the set of tables to reduce a size of the set of tables prior to processing the at least one join query.

13. The computer program product of claim 12, wherein the preprocessor preprocesses the set of tables to remove one or more rows of one or more of the tables in the set of tables that have non-seed set labels in elements of the one or more rows.

14. The computer program product of claim 12, wherein the preprocessor preprocesses the set of tables to remove one or more tables in the set of tables that have only non-seed set labels in the elements of the one or more tables.

15. The computer program product of claim 11, wherein performing the label reduction comprises:
generating, by machine logic, a mutex group of operators from the plurality of operators; and
executing, by the machine logic, the label reduction operation using the mutex group of operators to reduce a number of labels, present in the reduced version of the action space, relative to a number of labels in the original version of the action space.

16. The computer program product of claim 15, wherein executing the label reduction operation comprises performing a partial ground of operators in the plurality of operators.

17. The computer program product of claim 15, wherein the mutex group is a lifted mutex group, wherein a lifted mutex group is a set of lifted predicates that produces a mutex group when grounded.

18. The computer program product of claim 11, wherein performing the label reduction on the initial version of the label set comprises identifying schematic operators and lifted mutex groups (LMGs) based on the initial version of the action space, and wherein representing the AI planning problem as a lifted successor generation problem comprising defining the AI planning problem, for each schematic operator, in terms of a subset of LMGs corresponding to the schematic operator.

19. The computer program product of claim 11, further comprising:
generating one or more plans for solving the AI planning problem based on the one or more applicable actions in the output.

20. An apparatus comprising:
at least one processor; and
at least one memory coupled to the at least one processor, wherein the at least one memory comprises instructions which, when executed by the at least one processor, cause the at least one processor to:
receive an artificial intelligence (AI) planning problem including definitions for a plurality of operators;
create an initial version of a label set, which defines an initial version of an action space, with the label set including a plurality of labels, and with each label of the plurality of labels respectively corresponding to the operators of the plurality of operators;
perform, automatically and by machine logic, a label reduction on the initial version of the label set to obtain a reduced version of the label set that defines a reduced action space, wherein the reduced version of the label set is a seed set;
represent the AI planning problem as a lifted successor generation problem comprising a set of tables and at least one join query on the set of tables;
execute a lifted successor generation module on the lifted successor generation problem using the seed set to process the at least one join query and generate one or more applicable actions as a solution to the AI planning problem; and
output the one or more applicable actions for the AI planning problem for further AI operations.
